(19) United States
(12) Patent Application Publication
(10) Pub. No.: US 2006/0146372 A1
(43) Pub. Date: Jul. 6, 2006

(54) System for distributing non-uniform rules for distributed capture operations

(76) Inventors: Jason Dean Bair, Flower Mound, TX (US); Jose Adan Gonzalez, Flower Mound, TX (US); Timothy Mark Robe, Grapevine, TX (US)

Correspondence Address: CARSTENS & CAHOON, LLP, P O BOX 802334, DALLAS, TX, 75380, US

(21) Appl. No.: 11/029,539

(22) Filed: Jan. 5, 2005

(51) Int. Cl. H04N 1/00

(52) U.S. Cl. 358/403; 358/474

(57) ABSTRACT

The present invention relates to an improved distributed captures system capable of distributing to a plurality of remote sites non-uniform rules, such as rules governing the indexing or transfer of documents scanned at such remote sites. Documents are captured at remote locations by scanning and indexing such documents using a web-based scan interface. Captured documents are transferred to a central location, where they are stored on a centralized image repository. The invention allows for documents to be indexed differently at each remote location. Other aspects of the distributed capture system also may be managed differently at each remote site.

### BACKGROUND OF THE INVENTION

1. Technical Field

The present invention relates to an improved distributed capture system. Specifically, the invention relates to a system and method for distributing to a plurality of remote sites non-uniform rules related to the indexing or transfer of documents scanned at such remote sites.

2. Description of Related Art

Many businesses are faced with the obstacle of how to transmit data and documents from remote locations to a centralized location. For example, larger banks typically gather many types of documents at their branch banks, such as checking account, mortgage, and car loan applications, and forward such documents to the bank's centralized location for processing and approval. Traditionally, such documents were mailed from the remote locations, such as bank branches, to the centralized location. There are a number of disadvantages to this traditional process; the most significant disadvantage is the delay associated with mailing.

Recently, businesses have begun using distributed capture systems to transmit documentation gathered at remote locations to the centralized location. An exemplary distributed capture system is depicted in FIG. 1. Distributed capture system 110 includes central server(s) 115 that communicates with multiple remote locations 125, 135 and 145 via a network 120 and/or the Internet. Each remote location includes a computer with a display device, such as CRT monitor or an LCD screen, a data entry device, such as a keyboard, and has access to network 120 and/or the Internet. Hard copies of documents are scanned into the computer to form a document image by way of document scanners 130, 140 and 150. Of course, each remote location may have multiple scanning stations and multiple document scanners. Scanned documents are transmitted from remote locations 125, 135 and 145 to central server(s) 115 via the Internet 120. Using such a distributed capture system, documents can be transmitted from remote locations to a central repository much more quickly-in a matter of seconds or minutes via upload to a server rather than as long as days through the mail.

### SUMMARY OF THE INVENTION

The present invention relates to an improved distributed captures system capable of distributing to a plurality of remote sites non-uniform rules, such as rules governing the indexing or transfer of documents scanned at such remote sites. Documents are captured at remote locations by scanning and indexing such documents. Captured documents are transferred to a central location, where they are stored on a centralized image repository.

The invention allows for documents to be indexed differently at each remote location. Other aspects of the distributed capture system also may be managed differently at each remote site. For example, remote locations may be directed to periodically contact the central location for the purpose of transferring newly captured documents to the central location. Remote locations may be directed to perform this task at different times. Also, remote locations may be directed to retain captured documents at the remote location for a period of time following transfer of said captured documents to the central location. Remote locations may be directed to retain documents for different periods of time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a distributed capture system constructed in accordance with an exemplary embodiment of the present invention.

FIG. 2 is a block diagram illustrating the primary components of an exemplary distributed capture system for the distributed capture system illustrated in FIG. 1.

FIG. 3 is a logical flowchart diagram illustrating a method for capturing documents in accordance with an exemplary embodiment of the present invention.

FIG. 4 is an exemplary display screen for the web-based scan interface described in FIG. 2.

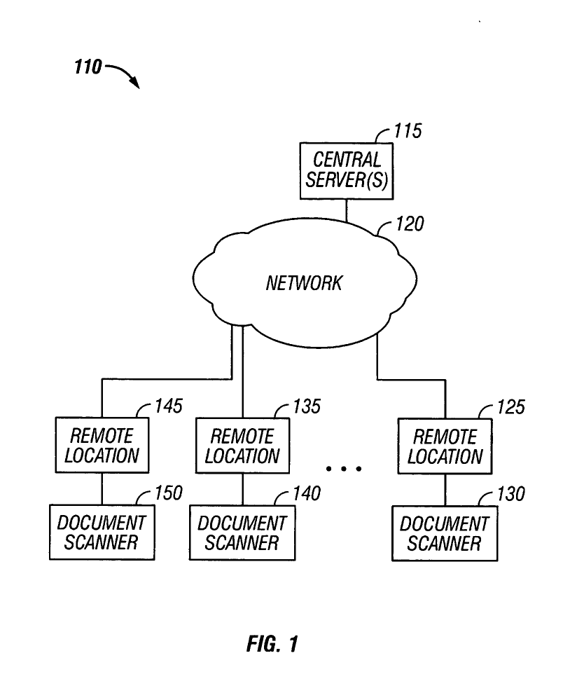

### DETAILED DESCRIPTION OF THE INVENTION

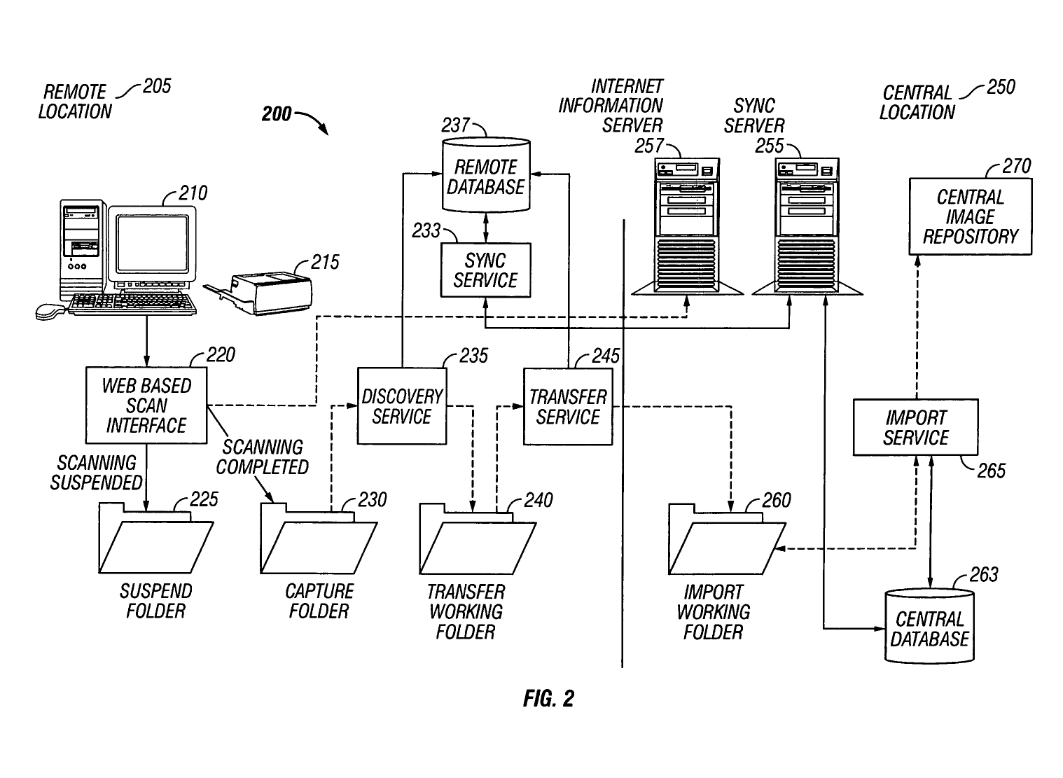

The innovative distributed capture system will now be discussed with reference to FIGS. 2 through 4.

FIG. 2. A depiction of an embodiment of the distributed capture system of the present invention 200 is in FIG. 2.

Remote location 205 is the site at which documents are collected for transmittal to central location 250. For instance, remote location 205 might be a bank branch. Remote location 205 includes document scanner 215, or some other means for creating a digital image out of documents collected at remote location 205. Connected to document scanner 215 is computer workstation 210, which includes a display device, such as CRT monitor or an LCD screen, a data entry device, such as a keyboard, and has access to the Internet.

Documents are scanned using document scanner 215 and indexed using web-based scan interface 220 running on computer workstation 210. One of ordinary skill in the art will appreciate that the document scanner may be a multi-function device, as opposed to a dedicated document scanner. Web-based scan interface 220 is run by computer workstation 210 by accessing Internet information server 257 by way of the Internet.

“Batches” consist of one or more scanned documents. Batches that have been indexed are said to have been “captured.”

Batches are indexed according to “rules” set at central location 250 by web based administration interface 252. Such rules, distributed by central location 250 to remote location 205, essentially govern the manner in which the document capture process at remote location 205 proceeds. In the case of indexing, rules are established to govern how web-based scan interface 220 identifies or describes batches. Thus, for each document scanned by document scanner 215, the user should be required to at least identify the batch content type, the transfer destination, and route distribution.

Batch content type essentially answers the question, “What type of document is it?” For each batch content type there may be any number of custom fields identifying such information as the loan number, social-security number, and the like. Of course, the custom fields will be tailored for each different batch content type. Therefore, each different batch content type may have different custom fields.

Transfer destination answers the question, “Where should the batch be sent?” In most instances, the proper transfer destination is “import,” that is the batch should be imported to central location 250. Alternatively, a batch may not need to be transferred to central location 250 but maintained at remote location 205 or transferred to another central or regional location or some other location, in which case the user would so specify.

Route distribution refers to what to do with the batch when it arrives at central location 250. The distributed capture system may be designed so that a batch is directed to the attention of a specific individual, group, unit, division or the like at central location 250 upon transfer of said document into central image repository 270. For example, a closing file scanned at a remote bank branch may need to be routed to the bank headquarters file audit section at central location 250. The distributed capture system obviously may also be designed so that a particular type of batch arriving at central location 250 may be viewed by anyone with authority or permission to see such documents.

During indexing, a prioritization for the document being captured may also be established. For example, central location 250 may desire to prioritize the transfer of batches from remote location 205 to make important documents available on central image repository 270 more quickly. This could be accomplished by having central location 250 automatically establish the priority of a batch based on the batch content type, such as automatically setting a priority of “1” or “highest” for all loan closing documents or a priority of “5” of “lowest” for all change of address forms. Central location 250 may also allow a user(s) at remote location 205 to override the automatically selected priority. Of course, central location 250 may prefer to have remote location 205 independently select a priority for a given batch based on the circumstances.

Documents scanned by document scanner 215 but for which indexing has not been completed may be stored in suspend folder 225. Indexing of such batches may be completed later using web based scan interface 220. Until indexing is completed, such documents are stored in suspend folder 225.

Indexed batches are transferred to capture folder 230, where they remain at least until the process of transferring said documents to central location 250 begins. Preferably, the batches also are retained at the remote location so that, for instance, the remote location can easily access documentation that was generated by it.

Discovery service 235 discovers whether there are any new batches in capture folder 230 whose transfer destination is central location 250; that is to say, batches that have not already been transferred to transfer working folder 240 but that must be. Discovery service 235 may identify new batches in capture folder 230 by querying capture folder 230 for the existence of trigger files. If discovery service 235 thereby discovers new batches in capture folder 230, it moves such new batches to transfer working folder 240 and directs them to be processed by transfer service 245. Discovery service 235 then creates a record in remote database 237 of which batches were transferred to transfer working folder 240.

Transfer service 245 queries remote database 237 to determine whether any new batches have been transferred to transfer working folder 240. If there are such new batches, then transfer service 245 directs said batches in transfer working folder 240 to be transferred to import working folder 260 located at central location 250. Batches should be transferred to important working folder 260 in order of priority, from highest priority to lowest. A rule may be established by central location 250 or remote location 205 to direct transfer service 245 to perform this task at set times, such as every ten minutes or once per day at a specific time. Of course, the times at which this task is performed might also be established as a default setting when distributed capture system 200 is originally configured. Obviously, distributed capture system 200 can be designed so that transfer service 245 may also be activated sporadically as needed by authorized users at central location 250 and/or remote location 205. Also, as noted above, the distributed capture system may be designed so that batches are retained in transfer working folder 240 for zero to n days after transfer service 245 moves said batches to import working folder 260.

After batches are transferred to import working folder 260, import service 265 directs said batches to be transferred to central image repository 270, which also could be located at central location 250. Import service 265 then creates a record in central database 263 of which batches were transferred from import working folder 260. As noted earlier, distributed capture system 200 can be designed so that batches in central image repository 270 are made available on an unlimited or limited basis to central location 250 and/or remote location 205.

Sync service 233 performs multiple functions. Firstly, sync service 233 performs the data synchronization between remote database 237 at remote location 205 and central database 263 at central location 250. Such data synchronization may be useful for many reasons.

Sync service 233 also is the mechanism through which remote location 205 and central location 250 communicate to transmit and set new “rules” for central location 205, if any. As stated above, rules are distributed by central location 250 to remote location 205 and essentially are the operating instructions for remote location 205 to follow in capturing documents.

Indexing rules were described in detail above. Sync service 233 enables central location 250 to communicate new indexing rules or changes in existing indexing rules to remote location 205. For instance, remote location 205 may begin processing a new batch content type, in which case central location 250 will need to transmit and set the rules, including custom fields, for said new batch content type. Or, central location 250 may want to make changes to the rules governing an existing batch content type already being processed at remote location 205, such as by adding or removing custom fields. Thus, central location 250 may adapt the rules governing the indexing of scanned documents to account for changing operating conditions at remote location 205.

Of course, remote location 250 may set rules other than indexing rules. For instance, central location 250 may configure distributed capture system 200 such that remote location 205 contacts central location 250 periodically, such as every thirty minutes, to upload new batches whose transfer destination is central location 250. Or, remote location 205 may be directed by central location 250 to retain batches in transfer working folder 240 for zero to n days following transfer of such batches to import working folder 260 at remote location 250. One of ordinary skill in the art will appreciate that it may be beneficial for central location 250 to set numerous other rules to govern operation of remote location 205.

Configuration of distributed capture system 200, including but not limited to the rules settings, is managed by web based administration interface 252 at central location 250. The existing configuration of distributed capture system 200 is stored on central database 263. Whenever changes to the configuration are desired, web based administration interface 252 has internet information server 257 pull the existing configuration from central database 263. Web based administration interface 252 then makes the desired changes to the configuration. Next, internet information server 257 transmits the new configuration back to central database 263, where said new configuration is stored. The new configuration is communicated to remote location 205 through sync server at central location 250 to sync service 233 at remote location 205.

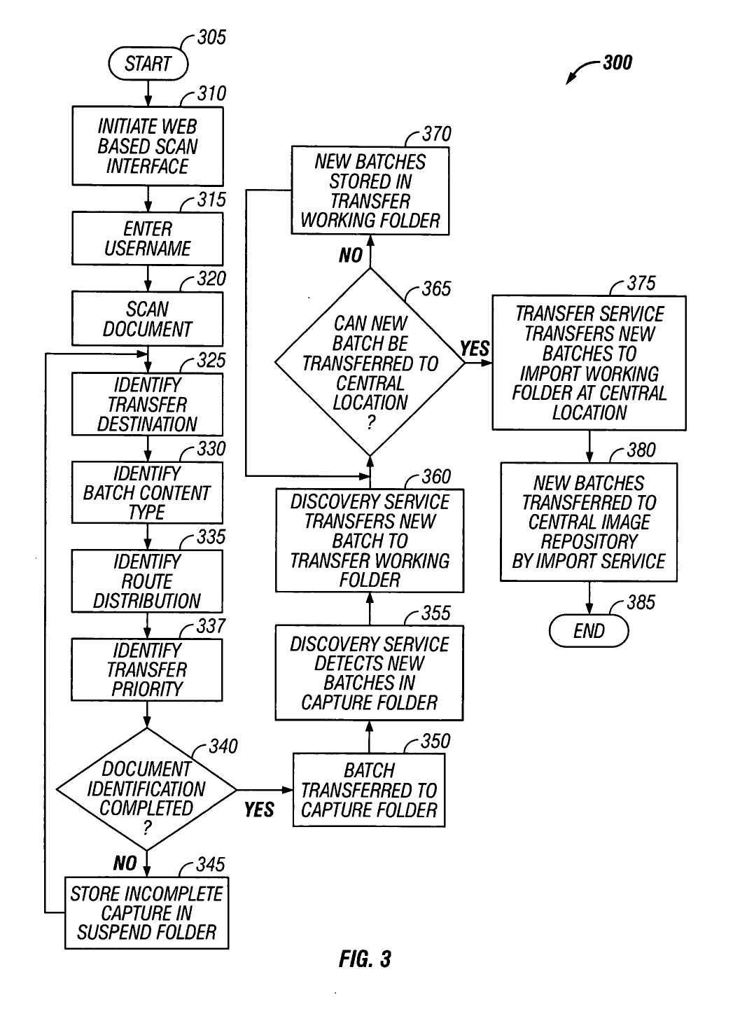

FIG. 3. A logical flowchart diagram is presented to illustrate the general tasks conducted by the distributed capture system of FIG. 2. A method 300 begins at START step 305 and proceeds to step 310, in which a web-based scan interface 220 is initiated on computer 210 at remote location 205.

In step 315, the user enters a username in the web-based scan interface 220. Based on the determination that the user is an authorized user, the process of capturing documents begins. In step 320, the user scans the batch that is going to be captured.

In step 325, the user identifies the transfer destination of the batch, i.e. where is batch going.

In step 330, the user identifies the batch content type of the batch. In other words, the user identifies what documents constitute the batch. In the banking context, the batch content type might be a car loan application, mortgage loan application, mortgage loan closing papers, etc. It should be appreciated that a virtually limitless number of custom fields, but preferably 20-30, may be associated with each batch. For example, the user may be required to identify for each batch, the loan number, the social security number, the date of execution, etc.

In step 335, the user identifies the route distribution of the batch, i.e., what to do with the batch when it arrives at the central location 250.

In step 337, the user identifies the transfer priority of the batch.

In the event that the batch content type, transfer destination, route destination and transfer priority are not identified in steps 325, 330, 335 and 337, the “NO” branch is followed to step 345 and the incomplete batch is stored in suspend folder 225. If no additional documents are to be added to the batch, another “NO” branch is followed and the user completes the batch identification in steps 325, 330, 335 and 337 at a later time. If additional documents are to be added to the batch, the “YES” branch is followed to step 320 instead.

If the batch content type, transfer destination, route destination and transfer priority are identified in steps 325, 330, 335 and 337, the “YES” branch is followed to step 350 and the batch is transferred to the capture folder 230.

In step 355, discovery service 235 detects whether there are any new batches in capture folder 230 whose transfer destination is central location 250. If so, in step 360, discovery service 235 transfers the new batches to transfer working folder 240 and proceeds to step 365, in which an inquiry is conducted to determine whether the new batches can be transferred to central location 250. If the response to this inquiry is negative, the “NO” branch is followed to step 370 and the new batches are stored in transfer working folder 240 at least until transfer of such new batches to the central location 250 can take place. Otherwise, the “YES” branch is followed from step 365 to 375.

In step 375, transfer service 245 transfers the new batches to import folder 260 at central location 250. Of course, said batches are transferred in order of priority, from highest priority to lowest priority. Then, in step 380, import service 265 transfers the new batches to central image repository 270. The process 300 is terminated at the END step 385.

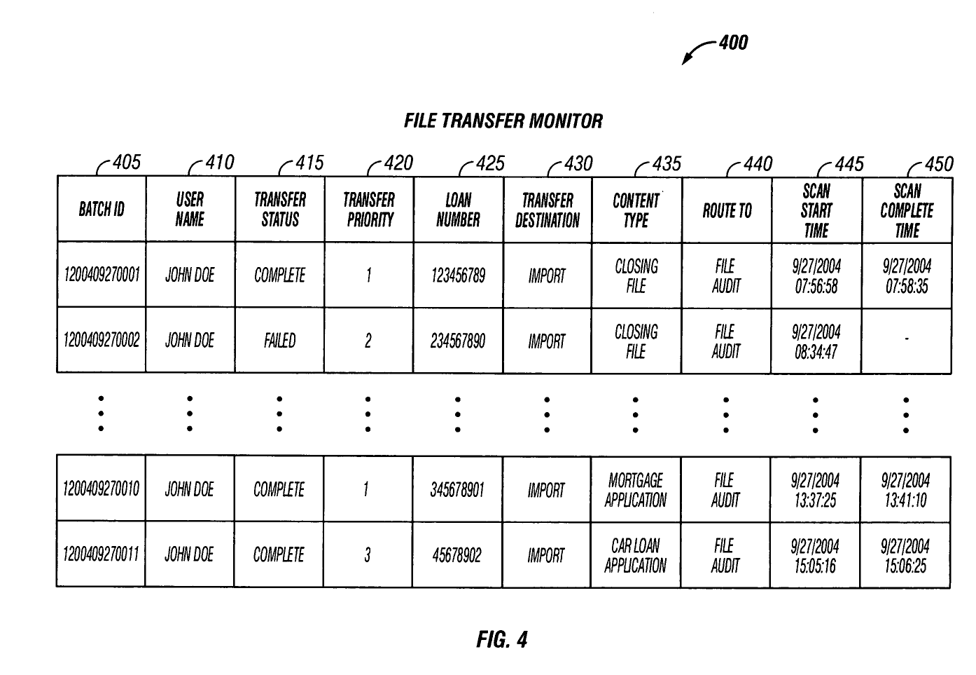

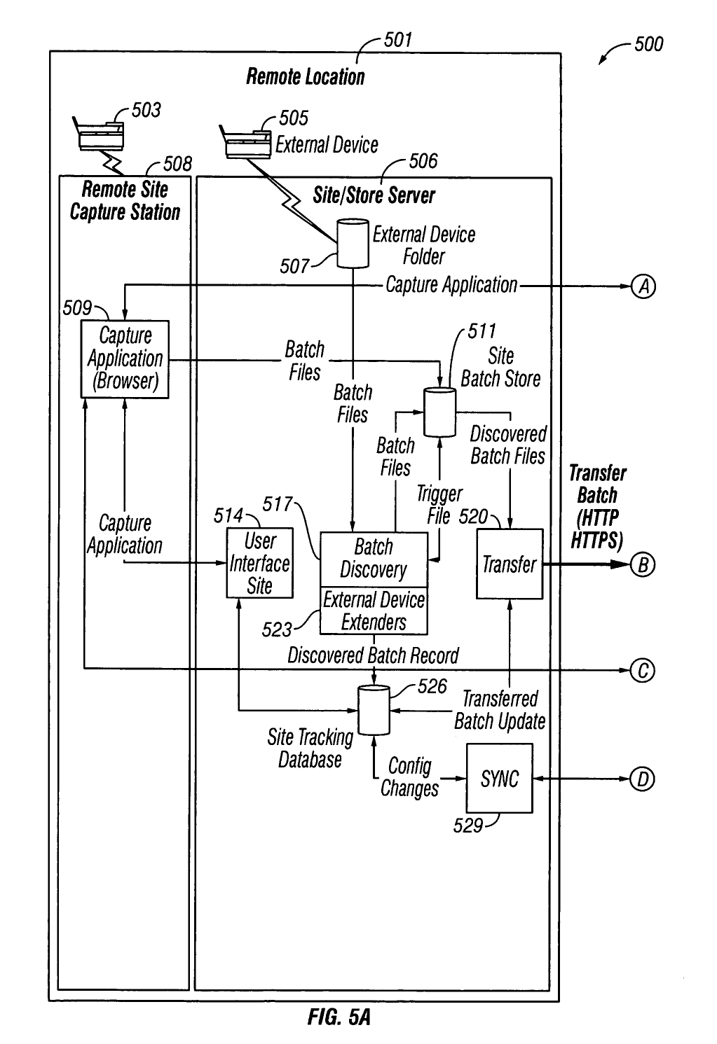

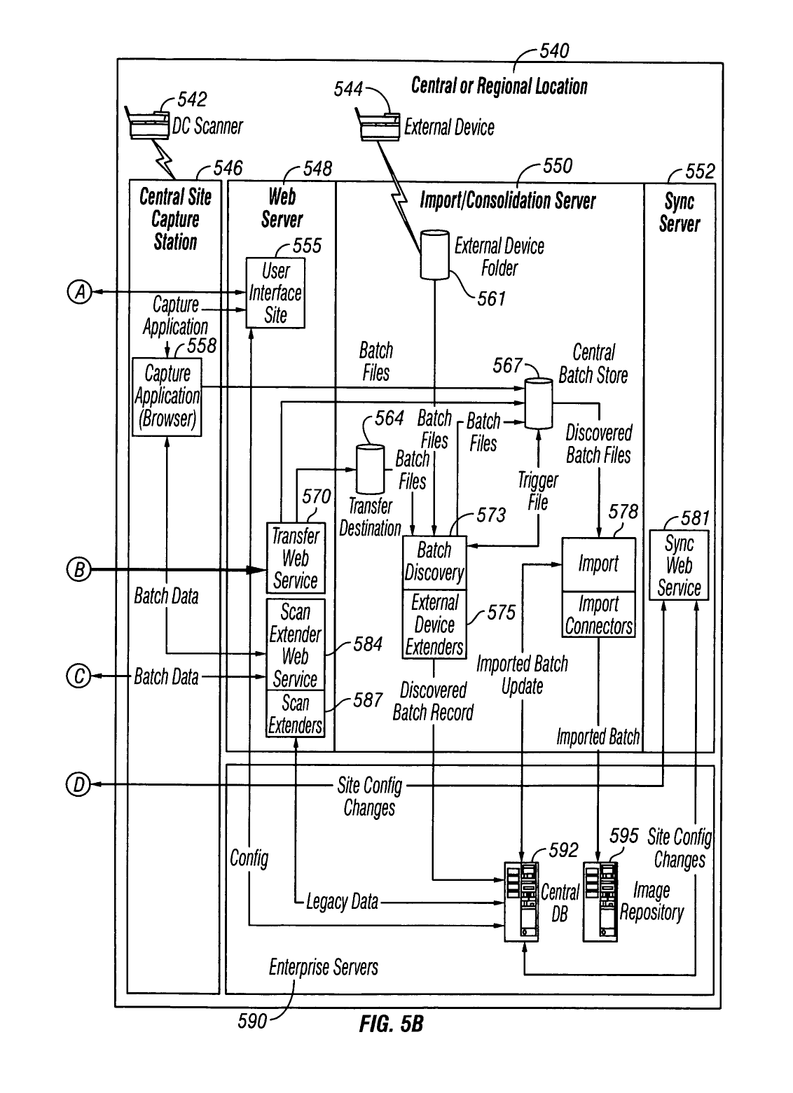

FIG. 4. Web-based scan interface 220 includes a file transfer monitor, visible on the display device of computer workstation 210, similar to that depicted in FIG. 4. File transfer monitor 400 is a depiction of the type of file transfer monitor that might be designed for use by a bank branch.

Batch ID 405 is a unique identifier associated with each separate batch. In one embodiment, a batch ID 405 is assigned. For example, it might consist of a site identifier, followed by the four-digit year, the two-digit month, the two-digit day of the month and a four-digit number representing sequentially what batch number for that day the batch represents. Thus, the fourth batch described in file transfer monitor 400 was the eleventh batch created on Sep. 27, 2004 at site “1”.

User name 410 represents the identity of the individual that used web-based scan interface 220 to capture that particular batch.

In the transfer status 415 column, the interface states whether transfer of a batch from transfer working folder 240 at remote location 205 to import working folder 260 at central location 250 has been completed. Transfer priority 420 references what transfer prioritization has been assigned to a batch. The transfer destination 430 column identifies where the batch is to be transferred. In the depicted column, all of the batches are to be imported to central location 250.

Content type 435 is a general description of the batch content type for a batch. Loan number 425 is an example of a custom field for each of the depicted content types. “Route to” 440 is the route distribution as described in greater detail above. In the case of the batches portrayed in file transfer monitor 400, wherein the remote location is a bank branch, the route distribution is the file audit section of the bank headquarters.

In the present embodiment, scan start time 445 and scan complete time 450 refer, respectively, to the time at which the process of scanning the documents comprising the batch begins and the time at which indexing of said documents is completed. A batch for which indexing has not been completed might not have an entry for scan complete time 450.

FIGS. 5A and 5B. A depiction of an alternative distributed capture system 500 in which documents may be captured at remote and central locations is in FIG. 5A and FIG. 5B.

FIG. 5A. Remote location 501 is a site at which documents are collected for transmittal to central location 540. As in the embodiment described with reference to FIG. 2, remote location 501 might be a bank branch.

Remote location 501 includes remote site capture station 508. Remote site capture station 508 has document scanner 503, or some other means for creating digital images out of documents collected at remote location 501. Batches are indexed at remote site capture station 508 using capture application 509. Batches are indexed as in the embodiment described with reference to FIG. 2. Batches captured at remote site capture station 508 are stored in site batch store 511 on site/store server 506.

Capture application 509 may be implemented through user interface website 514 on site/store server 506 at remote location 501 or through user interface website 555 on web server 548 at central or regional location 540 or on a web server at another central or regional location. Regardless of whether capture application 509 is implemented at remote location 501 or central or regional location 540, capture application 509 may take advantage of scan extender web service 584 and scan extenders 587. Scan extender web service 584 and scan extenders 587 basically are part of an interface for validating batch data. During indexing of documents, batch data, such as the loan number associated with the scanned documents, is received by scan extender web service 584. Scan extenders 587 then queries central database 592 to validate said batch data and/or to receive other data associated with said batch data. Distributed capture system 500 clearly can be designed so that scan extenders 587 query any external database or business logic. If said batch data is invalid, an error message may be displayed on capture application 509. If said batch data is valid and there is other data associated with said batch data, such other data may then be transmitted by scan extender web service 584 to remote location 501 to be used in capture application 509. For example, the user may enter the loan number associated with a document being indexed at remote site capture station 508. Through scan extender web service 584 and scan extenders 587, central database 592 may then be queried to determine whether said loan number exists on central database 592 and to provide any other information related to said loan number, including but not limited to the name, address, and telephone number associated with the loan number. That other information may then be transmitted to remote location 501 and automatically become populated, that is pre-filled, in capture application 509. One advantage of this process is that it helps reduce the amount of time users take to index scanned documents.

Each batch transferred from remote site capture station 508 to site batch store 511 preferably comprises two related files. Firstly, there is an image file associated with the batch. The image file is simply the digital image of the scanned documents. The image file commonly is a TIFF or JPEG file. Secondly, there is a trigger file associated with each batch. The trigger file contains non-image related data associated with that particular batch. For instance, it would include the data that was associated with a batch during the indexing process. Preferably, the trigger file is an XML file.

Remote location 501 also may include an external device 505, such as a fax machine. Documents that are received at remote location 501 by external device 505 are initially stored in external device folder 507. Batch discovery service 517 discovers new batches in external device folder 507 and transfers said new batches to site batch store 511.

Like batches created at remote site capture station 508, batches in external device folder 507 preferably comprise an image file and trigger file. In the case of files in external device folder 507, however, the trigger file may not be in a desirable or as useful format. If so, external device extenders 523 may be used to create a more desirable or useful trigger file. When a new trigger file is created, it replaces the old trigger file. Thus, only the new trigger file is transferred as part of the batch by batch discovery service 517 to site batch store 511.

Batch discovery service 517 also is involved in the process of tracking new batches in site batch store 511. Whenever batch discovery service 517 moves batches from external device folder 507 to site batch store 511, it creates a record in site tracking database 526 of the existence of a new batch in site batch store 511. Batch discovery service 517 also monitors site batch store 511 for trigger files received in site batch store 511 from capture application 509 and creates a record in site tracking database 526 of the existence of new batches received from remote site capture station 508.

Transfer service 520 queries site tracking database 526 to determine whether there are any new batches in site batch store 511. If there are such new batches, then transfer service 520 transfers said batches to central or regional location 540. Such transfer is preferably made via HyperText Transfer Protocol or HyperText Transfer Protocol Secure, but it also may be made via File Transfer Protocol or other method. After transfer from remote location 501 to central or regional location 540 is completed, transfer service creates a record in site tracking database 526 of which batches were transferred.

FIG. 5B. Batches transferred to central or regional location 540 are first received by transfer web service 570. Transfer web service 570 preferably places batches received from remote location 501 directly in central batch store 567. If for some reason it is unable to do so, such batches are simply moved into transfer destination folder 564 on import/consolidation server 550.

Batch discovery service 573 monitors transfer destination folder 564 for trigger files. Batch discovery service 573 receives trigger files first, which instruct batch discovery service 573 to move the trigger file's associated batch from transfer destination folder 564. Whenever batch discovery service 573 thereby discovers newly transferred batches in transfer destination folder 564, it transfers said newly transferred batches to central batch store 567, which also resides on import/consolidation server 550.

Central or regional location 540 also may include a capture station similar to remote site capture station 508 at remote location 501. Central site capture station 546 has document scanner 542, or some other means for creating digital images out of documents collected at remote location central or regional location 540. Documents are indexed at central site capture station 546 using capture application 558. Documents are indexed as in the embodiment described with reference to FIG. 2. Documents captured at central site capture station 546 are stored in central batch store 567 on import/consolidation server 550.

Capture application 558 should be implemented through user interface web site 555 on web server 548 at central or regional location 540. Scan extender web service 584 and scan extenders 587 perform the same function for capture application 558 as they do for capture application 509, which was described above.

Central or regional location 540 also may include an external device 544, such as a fax machine. Documents that are received at remote location 540 by external device 544 are initially stored in external device folder 561. Batch discovery service 573 discovers new batches in external device folder 561 and transfers said new batches to central batch store 567. External device extenders 573 process batches in external device folder 561 like external device extenders 523 process batches in external device folder 507. Batch discovery service

Like batch discovery service 517 at remote location 501, batch discovery service 573 also is involved in the process of tracking new batches in central batch store 567. Whenever batch discovery service 573 moves batches from external device folder 561 to central batch store 567, it creates a record in central database 592 of the existence of a new batch in central batch store 567. Batch discovery service 573 also monitors central batch store 567 for trigger files received in central batch store 567 from capture application 558 or directly from transfer web service 570 and creates a record in central database 592 of the existence of new batches received from central site capture station 546 or directly from transfer web service 570.

New batches in central batch store 567 are transferred to image repository 595 by import service 578. Import service 578 monitors central database 592 to determine whether there are any new batches in central batch store 567. If there are such new batches, then import connectors directs import service 578 to transfer said batches to image repository 595, which resides on enterprise servers 590. Note that there may be more than one image repository and that import connectors will direct batches to the appropriate image repository.

Distributed capture system 500 also includes a feature for effectuating configuration changes. Sync web service 581, which resides on sync server 552, queries central database 592 for any changes to configuration of distributed capture system 500 that need to be communicated to remote location 501. If there are such changes, sync web service 581 communicates said changes to sync service 529 on site/store server 506 at remote location 501. Sync service 529 then transmits said changes to site tracking database 526. Site tracking database 526 may effect changes to the configuration of remote location 501, including changes that need to be made to user interface site 514, as needed. Distributed capture system 500 configuration changes that should be made to user interface site 555 are communicated directly between central database 592 and user interface site 555.

It should be appreciated that distributed capture systems may include multiple remote locations and multiple central or regional locations. Also, any given remote location may communicate with any number of central or regional locations. Moreover, distributed capture system may include the capability for authenticating users of the distributed capture system and documents captured by the distributed capture system. Of course, the description of the present invention has been presented for purposes of illustration and description, but is not to be assumed to be exhaustive, nor is the invention intended to be limited to the form disclosed. Many modifications and variations will be apparent to those of ordinary skill in the art. The embodiment was chosen and described in order to best explain the principles of the invention to enable others of ordinary skill in the art to understand the invention for various embodiments with various modifications as are suited to the particular use contemplated.

We claim:

1. A distributed capture system comprising:
at least two remote locations;
at least one document scanner at each remote location;
at least one central location; and
means for distributing non-uniform rules to multiple remote locations.

2. The distributed capture system of claim 1 wherein said rules are indexing rules.

3. The distributed capture system of claim 2 wherein said indexing rules relate to a batch content type of a document.

4. The distributed capture system of claim 2 wherein said indexing rules relate to a same batch content type.

5. The distributed capture system of claim 2 wherein documents are indexed using a web-based scan interface.

6. The distributed capture system of claim 2 wherein documents may be scanned using a multi-function device.

7. The distributed capture system of claim 1 wherein said rules relate to a period of time that batches are retained at a remote location following transfer of said batches to a central location.

8. The distributed capture system of claim 1 wherein said rules relate to times at which a remote location transfers new batches to a central location.

9. A distributed capture system wherein multiple remote locations are capable of using different indexing rules for the same type of document.

10. A method of capturing documents from multiple remote locations, with each remote location having at least one document scanner, said method comprising the steps of:
distributing non-uniform rules to said remote locations; and
transferring captured documents to a central location.

11. The method of claim 10 wherein said rules are indexing rules.

12. The method of claim 11 wherein said indexing rules relate to a batch content type of a document.

13. The method of claim 11 wherein said indexing rules relate to a same batch content type.

14. The method of claim 10 wherein said rules relate to a period of time that batches are retained at a remote location following transfer of said batches to a central location.

15. The method of claim 10 wherein said rules relate to times at which a remote location transfers new batches to a central location.

16. The method of claim 11, further comprising the step of indexing documents using a web-based scan interface.
